(19) United States
(12) Patent Application Publication
(10) Pub. No.: US 2008/0194333 A1
(43) Pub. Date: Aug. 14, 2008

(54) System and method of providing assistance through incentives

(76) Inventor: Gary Zalewski, Oakland, CA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/986,551

(22) Filed: Nov. 21, 2007

Related U.S. Application Data
(60) Provisional application No. 60/860,938, filed on Nov. 22, 2006.
(60) Provisional application No. 60/860,937, filed on Nov. 22, 2006.
(60) Provisional application No. 60/860,936, filed on Nov. 22, 2006.

(51) Int. Cl. A63F 13/10; A63F 13/12

(52) U.S. Cl. 463/42; 463/43

(57) ABSTRACT

A system and method is provided for in-game assistance. In one aspect, gestures of a guide at a second terminal are presented to a player of a game at a first terminal. The guide may receive incentives for assisting the player, and may also provide verbal commands and game commands to the first terminal in response to observing gestures of the player.

### CROSS-REFERENCE TO RELATED APPLICATIONS

This application claims the benefit of the filing date of U.S. Provisional Patent Application Nos. 60/860,936, 60/860,937 and 60/860,938, all filed Nov. 22, 2006, the disclosures of which are all hereby incorporated herein by reference. U.S. patent application Ser. No. 11/382,032, is hereby incorporated by reference.

### BACKGROUND OF THE INVENTION

The present invention is directed to interactive entertainment systems such as gaming systems and, in one regard, to enabling players of a video game using such systems to more quickly become proficient at the game or its new release.

As new video games and new versions of existing video games are released, the complexity of such games has grown. This increases the difficulty for players of the video game to become adept at the game. With each advance in video gaming, becoming proficient merely by repeat play of the video game, for example, requires additional time and may not even be possible. Thus, instruction is required for a player to become proficient at playing the game.

Presently, when a player first plays a video game or a new release of a video game, the aids available to help the player often have limitations. As an example, user manuals, help screens, and on-line help pages are sometimes difficult to refer to in the course of a game. Moreover, such user manuals, help screens and on-line help pages are limited in the types of strategies and tactics that can be taught as such information is often situation dependent. Alternatively, on-line or stored tutorials may be provided to assist the player but the often have similar limitations

It is therefore desirable to be able assist a new player of a video game or a player of a new version of a video game while the game is played.

### SUMMARY OF THE INVENTION

According to a method and a system of the invention, in-game assistance is provided regarding playing a video game. A first device is provided and is operable by a guide to play a video game. Game commands generated by the guide during play of the video game are received at the first device. A sequence of images are generated, each of which includes an image of the video game and an associated guide image overlaying a portion the video game image. The guide image shows phantom hands operating a video game controller. The sequence of images depicts the game commands generated by the guide by showing the phantom hands carrying out the game commands on the video game controller such that an effect of each of the game commands on the video game is shown.

According to another method and system of the invention, in-game assistance is provided at a first user device to a video game player playing a video game. A second user device that communicates with the first user device is provided, the second user device being operated by a guide. Gestures, images and sounds generated by the first user device while the video game player plays the video game are delivered to the second user device for observation by the guide. Verbal comments and/or game commands provided by the guide are received at the second user device. The verbal comments and/or game commands are delivered to the first user device while the video game player plays the video game and are incorporated into the presentation of the video game at the first user device.

According to a further method and system of the invention, in-game instruction for playing a video game is provided. A first user device for displaying the video game and a second user device for generating a tour of the video game are provided. The second user device is operated by a guide. A video conferencing arrangement is provided whereby the second user device communicates with the first user device. At the second user device, at least one of verbal comments and game commands provided by the guide are received. The video game and the at least one of verbal comments and game commands are delivered to the first user device while the guide plays the video game. The at least one of verbal comments and game commands are incorporated into the presentation of the video game at the first user device.

As a result, the time required for a novice player to become comfortable with the video game or for other players to become comfortable with a new version of the video game is reduced.

### BRIEF DESCRIPTION OF THE DRAWINGS

FIG. 1 is a diagram illustrating an aspect of the invention in which a video game platform used by a player, a terminal used by a guide, and a server are connected to each other over a network.

FIG. 2 is a diagram illustrating another aspect of the invention in which a user terminal used by a player, a video game server, and a terminal used by a guide are connected to each other over a network.

FIG. 3 is a diagram illustrating a further aspect of the invention in which a video game platform used by a guide, other video game platforms used by players, and a server are connected to each other over a network.

FIG. 4 is a diagram illustrating a still further aspect of the invention in which a video game platform used by a guide, user terminals, and a server are each connected to a network.

FIG. 5 is a diagram depicting a video game monitor showing an image from a video game and showing “phantom hands” and a video game controller.

The foregoing aspects, features and advantages of the present invention will be further appreciated when considered with reference to the following detailed description and accompanying drawings.

### DETAILED DESCRIPTION

The present invention enables a player of a video game to interact with a guide who may be another player, a tutor, a pre-certified game expert, a computer, a game tester, etc. The guide may communicate with the player. Communications may be provided verbally or by actual control of the game. The guide may control tools to project images, overlays, text and graphics onto the player's terminal. The guide may show the player around the gaming environment, teach the player various game strategies and tactics, or enhance the skills of the player, all while the game is played. The video game may provide such an option by providing a learning mode and/or by providing a button on the game console or on the game display that may be activated to initiate communication with the tutor, pre-certified game expert, or game tester during actual play of the game.

Tutoring or assistance to a group of players of the video game may also be provided over the network or over a conferencing infrastructure. Also, the player or players receiving tutoring or assistance may also be able to provide feedback to either the game developer or to the pre-certified expert or tutor by providing another in-game option.

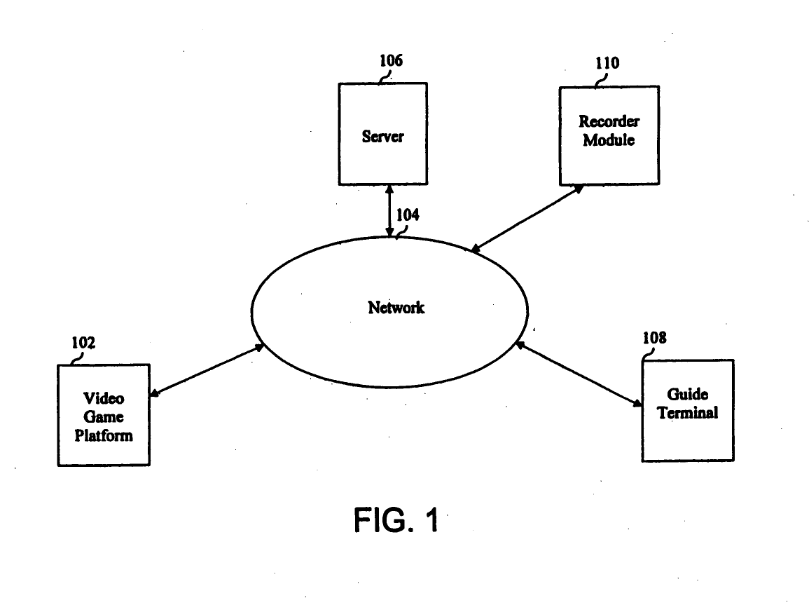

FIG. 1 illustrates an example of an arrangement in which the invention may be implemented. A video game platform 102 is connected over a network 104 to a guide terminal 108 and to a server 106.

The video game platform 102 is used by a player to play a video game using software and data stored in the video game platform. The video game platform may be suitable for home use and may include a game console, a display, a controller for receiving user input, and other components typically present in a video game platform as are known in the art. Alternatively, instead of the game console, the video game platform may include any user device that is capable of processing instructions, that is capable of transmitting information to and receiving information from other computers or devices, and that is capable of displaying information for viewing by a player and receiving commands from the player. Such devices include general purpose computers, network computers lacking local storage capability, PDAs with modems and Internet-capable and other wireless phones, digital video recorders, video-cassette records, cable television set-top boxes or consumer electronic devices, as are also known in the art. Thus, for example, the video game platform 102 may include a personal computer, a keyboard, a mouse, and a display. As a further alternative, the video game platform 102 may be an arcade system.

The guide terminal 108 is operated by a guide, who may be another player, a tutor, a pre-certified game expert, a computer, a game tester, etc. Alternatively, a second video game platform is provided in place of the guide terminal 108.

The video game platform 102 communicates with guide terminal 108 over the network 104 when the player at the video game platform 102 requests assistance. The video game platform 102 and the guide terminal 108 may communicate over the network 104 via the server 106. Alternatively, the video game platform 102 and the guide terminal 108 communicate over the network 104 in a peer-to-peer arrangement, and the server 106 may be omitted. The network 104 may include one or more of a telephone network, a cable network, the Internet, an intranet, etc.

In accordance with the invention, the video game includes an in-game offering that allows the player at the video game platform to obtain in-game assistance. As an example, the video game may include a learning mode which, when the game is started in this mode, initiates a connection with the guide at the guide terminal 108. Alternatively, the standard operating mode of the video game or the learning mode provides a location on the screen that may be clicked by the player to initiate the connection with the guide at the guide terminal 108. As a further alternative, the connection with the guide terminal 108 is initiated by activating a control on the controller or keyboard of the video game platform.

The connection between the video game platform 102 and the guide terminal 108 may be implemented by the server 106. As an example, the video game platform 102 may transmit a request for in-game assistance to the server, and the server then selects a particular guide, such as the guide at the guide terminal 108, from a list of such guides that is stored at the server, determines whether a terminal associated with that guide is active, and initiates the connection between the video game platform and the terminal. Alternatively, the video game platform 102 may store such a list of guides and connect directly to the terminal over the network.

Upon initiation of the connection between the video game platform 102 and the guide terminal 108, signals representing the gestures, images and sounds generated by the video game platform 102 are transmitted over the network 104 for display at the guide terminal 108 so that the guide at the guide terminal 108 views the gestures and images of the game played at the video game platform 102 and also hears the sounds of the game. The guide terminal 108 may be provided with a microphone that is used by the guide to provide verbal instructions that are delivered as signals to the video game platform 102. Further, the guide terminal 108 may be provided with the capability of allowing the guide to operate the video game in some manner, such as controlling one or more characters in the game, controlling other aspects of the game, or having the same control capability as the player at the video game platform 102, by generating signals representing control operations carried out at the guide terminal 108 which are delivered to the video game platform 102. For example, the guide terminal 108 may provide the guide with ability to carry out some or all of the operations that are ordinarily available at a controller of the video game platform 102, such as tracking absolute orientation, acceleration along any vector, and joystick control operations. Preferably, the signals sent between video game platform 102 and the guide terminal 108 are compressed to reduce the quantity of information that is sent over the network 104.

Moreover, an image of a controller may be overlaid on the display of the video game platform 102 with “phantom hands” moving about the image of the controller to show the control operations being carried out at the guide terminal 108 by the guide. The images of the controller and the “phantom hands” may be generated at the guide terminal 108 while the guide operates the video, and signals representing these images are delivered over the network 104 to the video game platform 102. Alternatively, the images of the controller and the “phantom hands” may be generated by the video game platform 102 based on signals representing the control operations generated at the guide terminal 108 or, when communication is carried out via the server 106, may be generated by the server 106 based on the signals representing the control operations generated at the guide terminal 108. In this manner, the guide using the guide terminal 108 is able to view and hear the video game being played at the video game platform 102 and provide assistance to the player operating the video game platform.

A recorder module 110 may be provided to receive the transmitted signals and thereby record the operations carried out by the guide while controlling the game being played at the video game platform 102. Though the recorder module is shown as a separate unit that communicates over the network 104 with the guide terminal 108 and/or the video game platform 102, the recorder module may alternatively be incorporated into guide terminal 108, the video game platform 102, or, when present, the server 106.

The video game software stored at the video game platform 102 may optionally include the ability to receive feedback from the player, either in-game, during a suspension of the game, or after termination of the video game. In-game feedback may be delivered to the guide at the guide terminal 108, such as using a microphone connected to the video game platform, to allow the guide to determine whether the assistance provided is understood by the player at the video game platform. Feedback provided during a suspension of the game or after termination of the video game may be delivered to the guide or to the server 106, such as to provide an evaluation of the assistance provided.

To encourage experienced players to act as guides, incentives may be provided to such experienced players by the video game developer. The incentives may include free upgrades or discounts for purchasing future versions of the video game or free upgrades or discounts for purchasing other video games. Also, free or discounted play of arcade versions of the video game may be offered as an incentive.

Upon completing tasks designated by the guide, the video game player may also receive incentives. The incentives may be granted at the discretion of the tutor, automatically awarded by the game upon completion of particular tasks, or granted based on other criteria or combinations of criteria.

The earned incentives are preferably, but not necessarily, stored on the server. For example, the earned incentives may be stored in the game console.

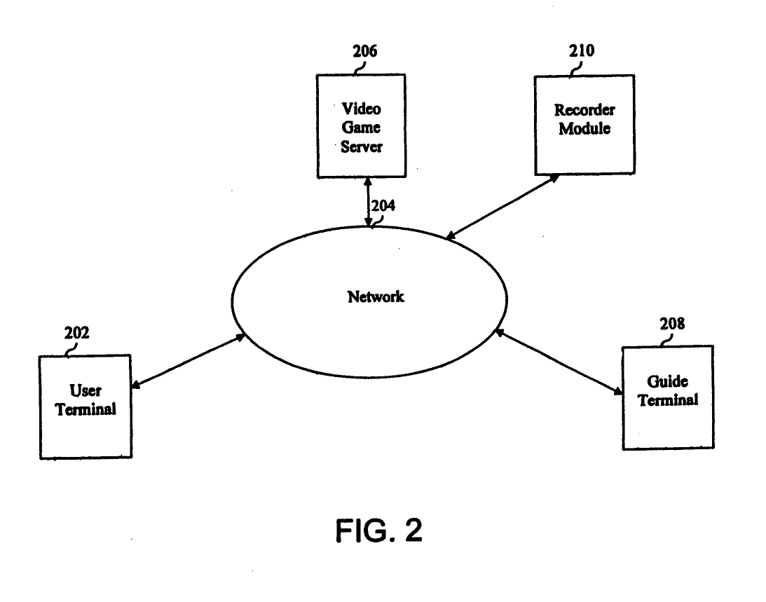

FIG. 2 illustrates another arrangement in which the invention may be implemented. Here, the player plays the video game at a user terminal 202 that is connected over a network 204 to a video game server 206 where the software for executing the video game is stored. The video game software performs the same actions described above regarding FIG. 1 except at the video game server 206 rather than at a video game platform. The video game server 206 is also connected over the network 204 to a guide terminal 208 that is operated by the guide in the manner described above. A recorder module 210 may also be provided as described above.

Using the arrangement shown in FIG. 1 or 2, the player at the video game platform is able to obtain help from a guide during actual play of the video game. As an example, if the player is new to the video game or is playing a new version of a video game already known to the player, the player can be walked through the environment of the video game by the guide, may receive instructions as to how to respond in a given situation, or may be shown possible results of a particular player action, etc. As a result, the player more quickly becomes familiar with the video game and can more easily learn the tactics and strategy needed to better play the game from the guide.

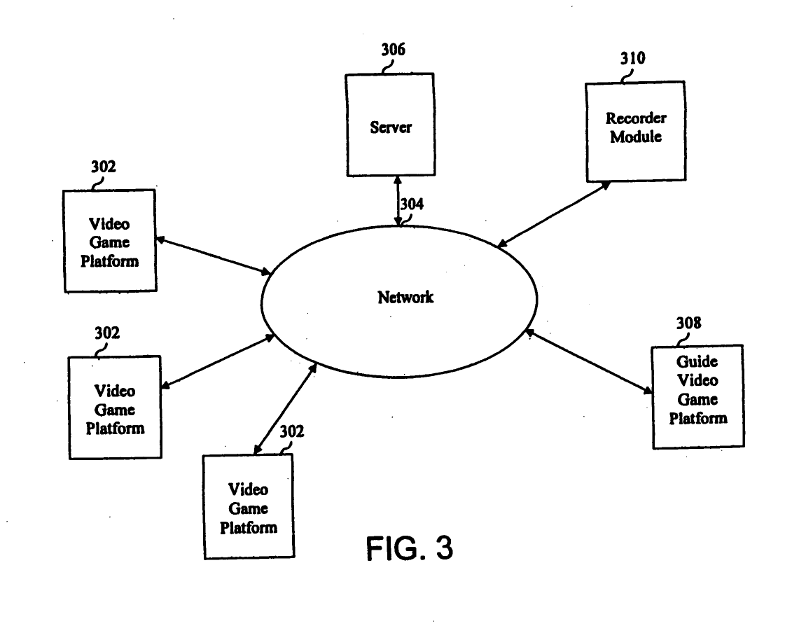

FIG. 3 shows a further arrangement that may be used to provide in-game tutoring or in-game “tours” of the video game. A video game platform 308 is operated by the tutor and is connected to one or more less experienced players at video game platforms 302, respectively, either directly over a network 304 or via a server 306 and the network 304. Alternatively, user terminals may be provided in place of the video game platforms 302. The network 304 may include the Internet and/or a video conferencing arrangement, such as is provided by WebEx™.

Alternatively, the video game software is stored at the server 306 and operates in the manner described above regarding FIG. 2.

In accordance with this aspect of the invention, the video game software is stored at the video game platform 308 and the gestures, images and sounds generated by the video game platform 308 are delivered to the video game platforms 302. The tutor at the video game platform 308 may either play the actual video game to provide instruction in the play of the actual game or may run a demo of the video game to provide a tour of the game environment. An image of a controller may be overlaid on the display of the video game platforms 302 together with “phantom hands” moving about the image of the controller to show the control operations being carried out, such as at the video game platform 308 when the actual game is being played by the guide. Also, when the actual game is played, the players at the video game platforms 302 may optionally also be able to play the video game. A microphone is provided at the video game platform 308 so that that the tutor may provide instructions or comments to the players at the video game platforms 302 as the game is played or during the tour.

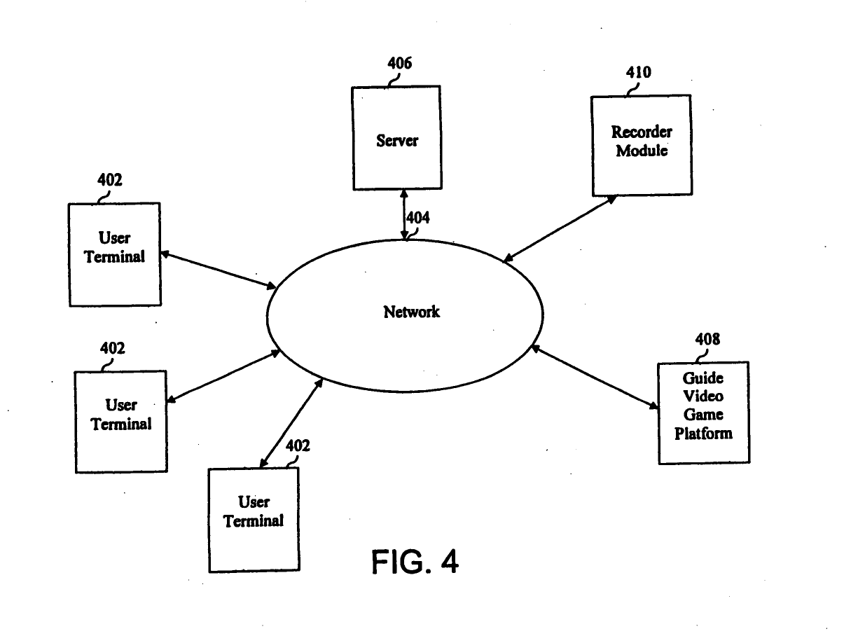

FIG. 4 shows a still further arrangement in which the guide operates a video game platform 408 and can provide real time or pre-recorded in-game instruction to one or more players at user terminals 402. The players at the user terminals 402 connect to the video game platform 408 over a network 404, such as over a peer-to-peer network or over the Internet via a server 406. As an example, a player at the user terminal 402 may connect over the Internet to a web site to access a video game played by the guide. The web site may provide games played by the guide in real-time using the video game platform 408, such as in response to requests by the user, and/or provide pre-recorded games which may include a live or recorded voice-over by the guide.

The guide may play part of a video game or an entire video game using the video game platform 408. A recorder module 410 may be included, either as a separate entity or combined with the server 406 or the video game platform 408, to record the video game or video game portion together with the game commands issued by the guide. The recorder module 408 may also record voice instructions provided by guide. Such recording may be carried out in advance of any user-requested assistance or may be carried out while the guide is providing real-time instruction and then replayed when requested by a user. The guide may show actions that would be carried out by a teammate of the player at the user terminal or may show actions that would be carried out by an opponent. An image of a controller may be overlaid on the display of the user terminal 302 together with “phantom hands” moving about the image of the controller to show the control operations being carried out while the game is played by the guide.

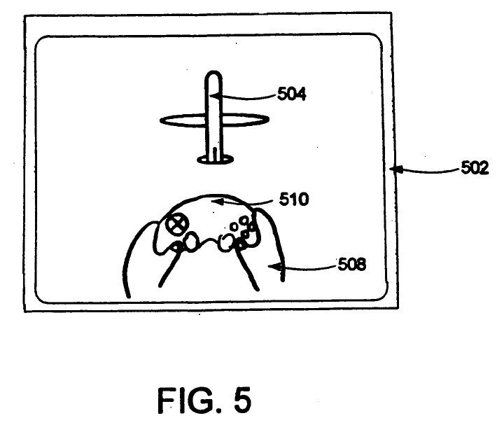

FIG. 5A shows an example of a monitor 502, such as may be located at the terminal or video game platform of a player described above, in which an image of “phantom hands” 508 and an image of a controller 510 are overlaid atop a portions of a video game image 504 in accordance with the invention. FIG. 5B shows the images of the “phantom hands” 508 and the controller 510 in greater detail.

Typically, the movements of the “phantom hands” 508 are synchronized with the actions shown in the video game image 504 to illustrate the gestures and manipulations performed and the game commands issued by the guide while playing a video game and to show their effect on the play of the game. As an example, the gestures, manipulations and issued commands shown by the “phantom hands” 508 allow the guide to show how these actions are affected by scoring metrics, game rules, and/or game boundaries.

To capture the guide's gestures and manipulations of the controller, the guide's terminal or video game platform includes a sensing capability which may be inertial sensing based, acoustic sensing based, video analysis based, infrared sensing based, or other tracking based. The captured gestures and manipulations of the guide are then used to generate the movements of the “phantom hands” and controller overlay of FIG. 5A. The generation of the “phantom hands” and controller overlay may be carried out at the guide's terminal or video game platform which then transmits signals representing the “phantom hands” and controller overlay, together with other signals providing other information about the play of the video game, either directly to the player's terminal or video game platform or to the server for retransmission to the player's terminal or video game platform. Alternatively, the guide's terminal or video game platform transmits to the server signals representing the captured gestures, manipulations and commands together with the other signals providing other information about the play of the video game. The server then generates the “phantom hands” and controller overlay, and when connected to a player, transmits the signals representing the “phantom hands” and controller overlay to the player's terminal or video game platform. The signals described above may also be compressed before being transmitted.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of providing in-game assistance regarding playing a video game, said method comprising:
providing a first device operable by a guide to play a video game;
receiving, at the first device, game commands generated by the guide during play of the video game; and
generating a sequence of images each of which includes an image of the video game and an associated guide image overlaying a portion the video game image, the guide image showing phantom hands operating a video game controller, the sequence of images depicting the game commands generated by the guide by showing the phantom hands carrying out the game commands on the video game controller such that an effect of each of the game commands on the video game is shown.

2. The method according to claim 1, wherein said generating step is carried out at the first terminal, and said method further comprises: transmitting, from the first terminal over a network to at least one of a server and a second terminal, signals representing the sequence of images.

3. The method according to claim 2, wherein the signals representing the sequence of images are transmitted to the second terminal, and said method further comprises: displaying the sequence of images at the second terminal.

4. The method according to claim 3, wherein the first terminal and the second terminal communicate with each other over a network via a server.

5. The method according to claim 3, wherein the first terminal and the second terminal communicate with each other over a peer-to-peer network.

6. The method according to claim 2, wherein signals representing the sequence of images are transmitted to the server, and said method further comprises: transmitting the signals representing the sequence of images from the server over the network to the second terminal concurrent with play of the video game at the first terminal, and displaying the sequence of images at the second terminal.

7. The method according to claim 2, wherein the signals representing the sequence of images are transmitted to the server, and said method further comprises: transmitting the signals representing the sequence of images from the server over the network to the second terminal subsequent to completion of play of the video game at the first terminal, and displaying the sequence of images at the second terminal.

8. The method according to claim 1, further comprising:
transmitting signals representing the game commands generated by the guide from the first terminal over a network to a server, said generating step being carried out at the server,
transmitting signals representing the sequence of images from the server over the network to the second terminal concurrent with play of the video game at the first terminal, and
displaying the sequence of images at the second terminal.

9. The method according to claim 1, wherein said receiving step includes providing a microphone at the second terminal, the microphone being used by the guide to provide verbal instructions, and said method further comprises: transmitting, from the first terminal over a network to at least one of a server and a second terminal, signals representing the verbal instructions.

10. The method according to claim 1, wherein said receiving step includes receiving game commands from the guide that control at least one of tracking absolute orientation, acceleration along a vector, and joystick operation.

11. The method according to claim 1, further comprising: recording the game commands provided by the guide.

12. A system, comprising:
a video game platform operable to receive game commands generated by a guide during play of a video game, to generate a sequence of images each of which includes an image of the video game and an associated guide image overlaying a portion the video game image, the guide image showing phantom hands operating a video game controller, the sequence of images depicting the game commands generated by the guide by showing the phantom hands carrying out the game commands on the video game controller such that an effect of each of the game commands on the video game is shown, and to transmit signals representing the sequence of images to a server or to a user terminal.

13. A system, comprising:
a video game platform; and
a server connected to said video game platform over a network;
said video game platform operable to receive game commands generated by a guide during play of a video game, and to transmit signals representing the game commands to said server; and
said server being operable to generate a sequence of images each of which includes an image of the video game and an associated guide image overlaying a portion the video game image, the guide image showing phantom hands operating a video game controller, the sequence of images depicting the game commands generated by the guide by showing the phantom hands carrying out the game commands on the video game controller such that an effect of each of the game commands on the video game is shown, and to transmit signals representing the sequence of images to a user terminal.

14. A method of providing in-game assistance to a video game player for playing a video game using a first terminal, said method comprising:
providing a second terminal that communicates with the first terminal, the second terminal being operated by a guide;
delivering, to the second terminal for observation by the guide, signals representing gestures generated by the first terminal while the video game player plays the video game;
receiving, at the second terminal, at least one of verbal comments and game commands provided by the guide; and
delivering signals representing at least one of verbal comments and game commands to the first terminal while the video game player plays the video game, the at least one of verbal comments and game commands being incorporated into the presentation of the video game at the first terminal.

15. The method according to claim 14, wherein the first terminal and the second terminal communicate with each other over a network via a server.

16. The method according to claim 14, wherein the first terminal and the second terminal communicate with each other over a peer-to-peer network.

17. The method according to claim 14, wherein communication between the first terminal and the second terminal is initiated by at least one of operating the video game in a learning mode, clicking a location on a display screen of the first terminal while the game is displayed, or by activating a control on a controller or a keyboard of the first terminal.

18. The method according to claim 14, wherein said receiving step includes providing a microphone at the second terminal, the microphone being used by the guide to provide verbal instructions.

19. The method according to claim 14, wherein said receiving step includes receiving game commands from the guide that control at least one of tracking absolute orientation, acceleration along a vector, and joystick operation.

20. The method according to claim 14, further comprising: overlaying images of a controller and phantom hands on a display of the first user terminal wherein the image of the phantom hands move to show control operations carried out at the second user terminal by the guide.

21. The method according to claim 14, further comprising: recording the game commands provide by the guide.

22. The method according to claim 14, further comprising: receiving, at the first terminal, feedback provided by the player, the feedback being provided in-game, during a suspension of the video game, or after termination of the video game.

23. The method according to claim 14, further comprising: providing one or more incentives to an experienced player of the video game to serve as the guide.

24. The method according to claim 23, wherein the one or more incentives are selected from the group consisting of a free upgrade for purchasing a future version of the video game, a discount for purchasing a future version of the video game, a free upgrade for purchasing another video game, a discount for purchasing another video game, a free play of an arcade version of the video game, and discounted play of an arcade version of the video game.

25. A method of providing in-game instruction for playing a video game, said method comprising:
providing a first terminal for displaying the video game;
providing a second terminal for generating a tour of the video game, the second terminal being operated by a guide;
providing a video conferencing arrangement whereby the second terminal communicates with the first terminal;
receiving, at the second terminal, at least one of verbal comments and game commands provided by the guide; and
delivering signals representing the video game and the at least one of verbal comments and game commands to the first terminal while the guide plays the video game, the at least one of verbal comments and game commands being incorporated into the presentation of the video game at the first terminal.

26. The method according to claim 25, wherein the first terminal and the second terminal communicate with each other over a network via a server.

27. The method according to claim 25, wherein the first terminal and the second terminal communicate with each other over a peer-to-peer network.

28. The method according to claim 25, wherein said receiving step includes providing a microphone at the second terminal, the microphone being used by the guide to provide verbal instructions.

29. The method according to claim 25, wherein said receiving step includes receiving game commands from the guide that control at least one of tracking absolute orientation, acceleration along a vector, and joystick operation.

30. The method according to claim 25, further comprising: overlaying images of a controller and phantom hands on a display of the first user terminal wherein the image of the phantom hands move to show control operations carried out at the second user terminal by the guide.

31. A system, comprising:
a first terminal operable to play a video game, said first terminal being operated by a video game player;
a second terminal operable to communicate with said first terminal, said second terminal being operated by a guide; and
a network operable to deliver, to said second terminal for observation by the guide, signals representing gestures generated by said first terminal while the video game player plays the video game;
said second terminal being operable to receive at least one of verbal comments and game commands provided by the guide;
said network being operable to deliver signals representing the at least one of verbal comments and game commands to said first terminal while the video game player plays the video game;
wherein the at least one of verbal comments and game commands are incorporated into the presentation of the video game at said first terminal.

32. A system for providing in-game instruction for playing a video game, comprising:
a first terminal operable to display the video game;
a second terminal operable to generate a tour of the video game, said second terminal being operated by a guide; and
a video conferencing arrangement whereby said second terminal communicates with said first terminal;
said second terminal being operable to receive at least one of verbal comments and game commands provided by the guide;
said video conferencing arrangement operable to deliver signals representing the video game and the at least one of verbal comments and game commands to said first terminal while the guide plays the video game;
wherein the at least one of verbal comments and game commands are incorporated into the presentation of the video game provided at said first terminal.
